(19) United States
(12) Patent Application Publication
(10) Pub. No.: US 2010/0180209 A1
(43) Pub. Date: Jul. 15, 2010

(54) ELECTRONIC DEVICE MANAGEMENT METHOD, AND ELECTRONIC DEVICE MANAGEMENT SYSTEM AND HOST ELECTRONIC DEVICE USING THE METHOD

(75) Inventors: Gyung Hye YANG, Seoul (KR); Sang Woong HWANG, Yongin-si (KR); Eun Young LIM, Seoul (KR); Ji Young KWAHK, Seongnam-si (KR); Bong Hyun CHO, Gwangju-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/728,505

(22) Filed: Mar. 22, 2010

Related U.S. Application Data
(63) Continuation-in-part of application No. 12/554,493, filed on Sep. 4, 2009.

(30) Foreign Application Priority Data
Sep. 24, 2008 (KR) 10-2008-0093727

(51) Int. Cl. G06F 3/048

(52) U.S. Cl. 715/748; 715/835; 715/764

(57) ABSTRACT

An electronic device managing method and system, and a host electronic device using the method are disclosed. The host electronic device may be connected to a plurality of client electronic devices. The host electronic device may perform file storage state management, remaining battery capacity management, and file reproduction management to integrally and efficiently managing the plurality of client electronic devices. The file storage state management includes managing file storage states corresponding to the memories of the plurality of client electronic devices. The remaining battery capacity management includes managing the remaining capacity of the batteries of the plurality of client electronic devices. The file reproduction management includes managing reproduction of at least one of the files stored in the plurality of client electronic devices.

### CROSS REFERENCE TO RELATED APPLICATION

This application is a continuation-in-part of U.S. patent application Ser. No. 12/554,493, filed on Sep. 4, 2009, and claims priority from and the benefit of Korean Patent Application No. 10-2008-0093727, filed on Sep. 24, 2008, which are hereby incorporated by reference for all purposes as if fully set forth herein.

### BACKGROUND OF THE INVENTION

1. Field of the Invention

Exemplary embodiments of the invention relate to electronic devices. In particular, exemplary embodiments of the invention relate to a method for integrally managing a file storage state, a remaining battery state, and a file reproduction state of at least one client electronic device, and to an electronic device system and a host electronic device using the method.

2. Description of the Background

In recent years, portable terminals have been widely used because they can be easily carried. For example, 85% of people in the Republic of Korea use portable terminals since portable terminals allow users to make a voice call while the users are moving. Such conventional portable terminals may provide a variety of functions in addition to the function of communicating voice call information between a caller and a called party. For example, the conventional portable terminal may have a file playback function, such as an MP3 player function, and an image collecting function, such as a digital camera. A conventional portable terminal can also support a function for playing a mobile game or an arcade game.

Conventional portable terminals have been developed to provide a variety of functions; however, batteries of the portable terminals have not been improved in terms of battery capacity. Consumers may purchase a variety of electronic devices, such as an MP3 player, a digital camera, and/or a play station portable (PSP) to enjoy specialized functions (i.e., media file reproduction, video image collection, games) which can be provided by the corresponding electronic devices described above. Users having multiple electronic devices must individually and directly manage the respective electronic devices to, for example, determine the battery status or information stored in each electronic device. However, this may be inconvenient and may cause confusion for electronic device users. For example, electronic device users must correctly memorize which electronic devices store what type of files. If an electronic device user does not memorize features of a particular electronic device which stores a specific file to be reproduced, the user must check all the electronic devices individually.

### SUMMARY OF THE INVENTION

Exemplary embodiments of the invention provide a method for integrally operating and managing at least one electronic device. Exemplary embodiments of the invention also provide an electronic device management system and a host electronic device using the method.

Additional features of the invention will be set forth in the description which follows, and in part will be apparent from the description, or may be learned by practice of the invention.

Exemplary embodiments of the invention disclose an electronic device managing method including displaying a graphical representation corresponding to a client electronic device on a display unit of a host electronic device including a touch screen function, collecting, by the host electronic device, information regarding at least one content of the client electronic device, and displaying at least one graphic element corresponding to the collected content information on the display unit of the host electronic device.

Exemplary embodiments of the invention disclose an electronic device management system including a host electronic device and a client electronic device. The host electronic device includes a display unit supporting a touch screen function. The client electronic device communicates with the host electronic device. The display unit of the host electronic device to display a graphical representation of the client electronic device. The host electronic device communicates with the client electronic device in response to the graphical representation of the client electronic device being displayed on the display unit of the host electronic device. The host electronic device collects content information regarding at least one content of the client electronic device. The host electronic device displays at least one graphic element corresponding to the collected content information on the display unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a schematic view illustrating an integrated management system according to exemplary embodiments of the invention.

FIG. 2 is a schematic block diagram illustrating a host electronic device according to exemplary embodiments of the invention.

FIG. 3 is a view illustrating a screen interface that displays information regarding file storage states of a plurality of client electronic devices 200, 300, and 400, according to exemplary embodiments of the invention.

FIG. 4 is a view illustrating a screen interface of a file storage state of an electronic device according to exemplary embodiments of the invention.

FIG. 5 is a view illustrating a screen interface of a file storage state in a client electronic device according to exemplary embodiments of the invention.

FIG. 6 shows a display unit of a host electronic device displaying states of a remaining battery capacity of each client electronic device according to exemplary embodiments of the invention.

FIG. 7 shows a display unit of a host electronic device displaying a list of files of each client electronic device according to exemplary embodiments of the invention.

FIG. 8 is a flow chart describing a method for managing file storage states of client electronic devices according to exemplary embodiments of the invention.

FIG. 9 is a flow chart describing a method for performing remaining battery capacity management and file reproduction management according to exemplary embodiments of the invention.

FIG. 10 is a view that describes a first method for operating an electronic device management system according to exemplary embodiments of the invention.

FIG. 11 is a view that describes a second method for operating an electronic device management system according to exemplary embodiments of the invention.

FIG. 12 is a view that describes a third method for operating an electronic device management system according to exemplary embodiments of the invention.

FIG. 13 is a view that describes a fourth method for operating an electronic device management system according to exemplary embodiments of the invention.

### DETAILED DESCRIPTION OF ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In the following description, a plurality of electronic devices is described based on a mobile communication terminal, for example, an MP3 player and/or a PSP. However, it should be understood that the electronic devices may be implemented using various types of terminals, such as, for example, mobile communication terminals, personal digital assistants (PDAs), Wibro terminals, and/or portable multimedia players (PMPs).

Hereinafter, exemplary embodiments of the invention are described in detail with reference to the accompanying drawings.

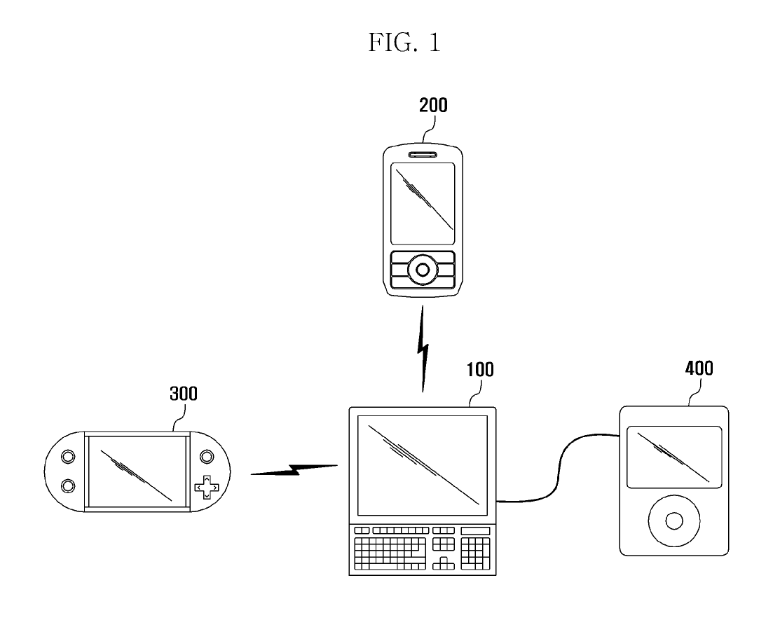

FIG. 1 is a schematic view illustrating an integrated management system according to exemplary embodiments of the invention.

Referring to FIG. 1, the electronic device management system may include a plurality of client electronic devices 200, 300, and 400, and a host electronic device 100.

The plurality of client electronic devices 200, 300, and 400 may be implemented with various types of terminals, such as, for example, a mobile communication terminal, a file reproducing terminal, a PSP terminal, and an electronic dictionary. An example of the file reproducing terminal is an MP3 player. The plurality of client electronic devices 200, 300, and 400 may have an interface connectable to the host electronic device 100. The plurality of client electronic devices 200, 300, and 400 may store various files, such as, for example, music files, movie files, photograph files, and/or document files. For example, a first client electronic device 200 may store the first to third music files, and a first movie file; a second client electronic device 300 may store the fourth to sixth music files and a second movie file; and a third client electronic device 400 may store the first, second, and fifth music files. The plurality of client electronic devices 200, 300, and 400 can manage the respective files in a list. Therefore, if a client electronic device 200, 300, or 400 is connected to the host electronic device 100, the client electronic device 200, 300, or 400 can transmit a corresponding list of files to the host electronic device 100. The plurality of client electronic devices 200, 300, and 400 can provide information related to a file storage state to the host electronic device 100 so that the host electronic device 100 may manage the stored files. If the plurality of client electronic devices 200, 300, and 400 are connected to the host electronic device 100, they may recharge their batteries by receiving electric power supplied from the host electronic device 100. A battery recharging order can be determined according to an electronic device use history information or according to the battery charged state. For example, the host electronic device 100 may perform a battery recharge of one of the batteries of the plurality of electronic devices 200, 300, and 400 that has the lowest remaining battery capacity. The host electronic device 100 can also determine the recharge priority order according to a frequency of use of the plurality of electronic devices 200, 300, and 400.

Accordingly, via the host electronic device 100, the plurality of electronic devices 200, 300, and 400 may share and manage the file storage state, recharge batteries, and perform a corresponding operation based on the electronic device use history information. An example of a corresponding operation is managing file reproduction.

The connecting interfaces of the plurality of electronic devices 200, 300, and 400 can be implemented in various forms. For example, the first client electronic device 200 may have a universal serial bus (USB) cable as a connecting interface, the second client electronic device 300 may have a short-range wireless communication module-based connecting interface, and the third client electronic device 400 may have a universal asynchronous receiver transmitter (UART) cable. In general, any suitable connecting interface or combination of connecting interfaces may be used.

The host electronic device 100 may have interfaces to which the plurality of client electronic devices 200, 300, and 400 are connected, so that the host electronic device 100 can receive information regarding the file storage states and information regarding battery states from the respective client electronic devices 200, 300, and 400, and can temporarily store the information. The host electronic device 100 can display the information regarding file storage states received from the plurality of client electronic devices 200, 300, and 400 on a display unit of the host electronic device 100, and can alter or modify the file storage states according to a user's touch events. The host electronic device 100 may receive information regarding battery states from the client electronic devices 200, 300, and 400 to determine the remaining battery capacities of the respective client electronic devices 200, 300, and 400, so that the host electronic device 100 can recharge the batteries of at least one of the client electronic devices 100, 200, and 300 according to a preset priority order.

The host electronic device 100 may receive lists of files stored in the client electronic devices 200, 300, and 400, and may allow a corresponding client electronic device 100, 200, or 300 to reproduce a corresponding file according to a user's touch event. The host electronic device 100 can store use history information indicating which file was reproduced in a client electronic device 100, 200, or 300.

The host electronic device 100 can have a variety of connecting interfaces to which the plurality of client electronic devices 200, 300, and 400 are connected, respectively. The host electronic device 100 may be implemented using a variety of electronic devices, such as, for example, a television, a large format display (LFD), and/or a table top. The television may be configured to have interfaces that can be used for communicating with client electronic devices 200, 300, and 400. The LFD may be vertically installed and may have interfaces that can be communicated with client electronic devices 200, 300, or 400. The table top may also be horizontally installed and may have interfaces that connect to client electronic devices 200, 300, and 400. It should be understood that the host electronic device 100 can also be implemented with a PDA, a tablet PC, and/or a nettop computer.

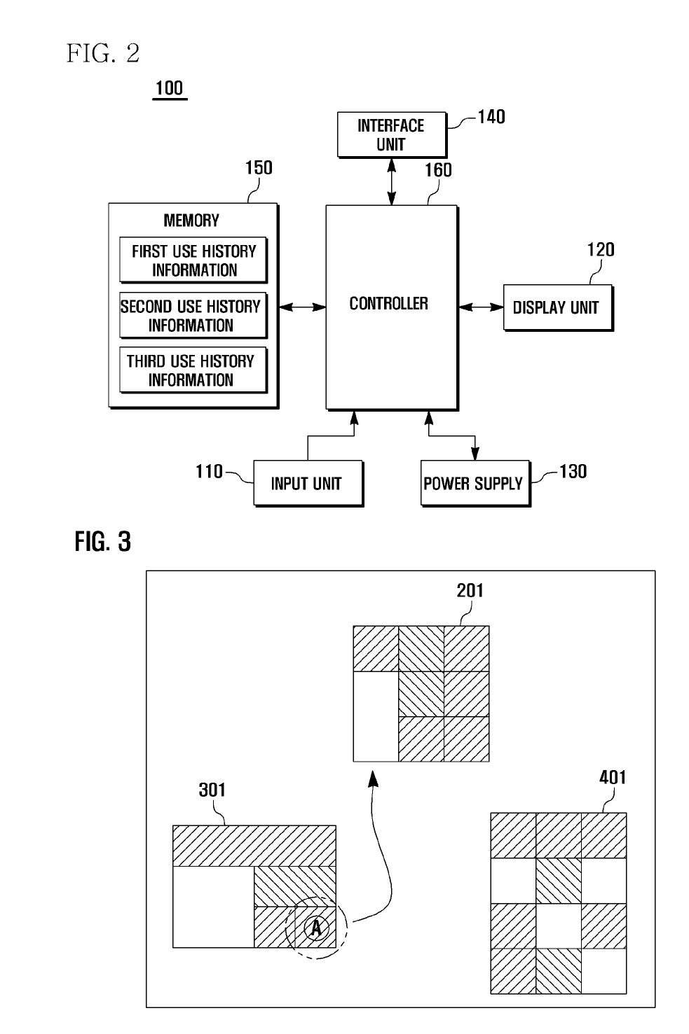

The configuration of the host electronic device 100 is described in detail with reference to FIG. 2. FIG. 2 is a schematic block diagram illustrating the host electronic device 100 according to exemplary embodiments of the invention.

Referring to FIG. 2, the host electronic device 100 may include an input unit 110, a display unit 120, a power supply 130, a connecting interface unit 140, a memory 150, and a controller 160. In general, the host electronic device 100 may include any suitable element related to managing the client electronic devices 200, 300, and 400. For example, the host electronic device 100 can further include an audio processing unit for processing audio signals, a camera, a broadcast receiving module, and/or a Global Positioning System (GPS).

The input unit 110 may include a plurality of input keys and function keys that receive numerical or letter information input by a user and set a variety of functions. The function keys may include direction keys, side keys, and/or shortcut keys, which are set to perform specific functions. The input unit 110 may generate key signals related to user settings and function controls of the host electronic device 100, and may transmit the key signals to the controller 160. If the host electronic device 100 is manufactured with a full screen-based touch screen, the touch screen may be used as the input unit 110. The input unit 110 may generate a variety of input signals, according to a user's input, for example, a click or touch and drag. The input unit 110 may then transmit the variety of input signals to the controller 160. Examples of the input signals include a signal for requesting file storage states of the plurality of client electronic devices 200, 300, and 400, a signal for moving, copying, or deleting files between the client electronic devices 200, 300, and 400 while the respective file storage states are displaying a signal for requesting lists of files stored in the respective client electronic devices 200, 300, and 400, and a signal for reproducing a specific file contained in the lists of files.

The display unit 120 may display various menus, information input by a user, and information provided to the user. The display unit 120 can display a variety of screens (e.g., a standby screen, a menus screen, a file management screen, a battery management screen, and a file selection and reproduction screens) as the host electronic device 100 is used.

The display unit 120 may be implemented as a touch screen so that the display unit 120 can also serve as an input device. The display unit 120 can display file storage states in a geometric diagram, such as a two- or three-dimensional diagram, according to an input signal of the input unit 110. The display unit 120 can also display current processes and functions, such as moving, copying, and deleting of files, based on file storage states in the client electronic devices 200, 300, and 400. The display unit 120 can display states of the remaining battery capacities of the client electronic devices 200, 300, and 400, and can also display the recharge priority order of batteries of the client electronic devices 200, 300, and 400, according to the user's setting or a preset setting. The battery recharge priority order can be altered according to an input signal of the input unit 110. If the battery recharge priority order is altered, the display unit 120 can display a corresponding state to reflect the alteration.

The power supply 130 may supply electric power to the host electronic device 100. The power supply 130 may be implemented with one or more rechargeable batteries that support the mobility of the host electronic device 100. The power supply 130 may have a cord that can be connected to a plug receptacle to supply electric recharging power to the client electronic devices 200, 300, and 400 connected to the host electronic device 100. The host electronic device 100 may have an electric power interface that can be connected to a primary battery to receive emergency power. If the plurality of client electronic devices 200, 300, and 400 are connected to the power supply 130, the power supply 130 may recharge the batteries of the client electronic devices 200, 300, and 400 according to the priority order under the control of the controller 160. In some cases, the power supply 130 may only supply electric power for operating the host electronic device 100, and may not recharge the batteries of the client electronic devices 200, 300, and 400.

The connecting interface 140 may be implemented by a variety of interfaces that can be connected to the plurality of client electronic devices 200, 300, and 400. As described above, the connecting interface 140 may have one or more interfaces such as, for example, a USB cable interface, a UART cable interface, and a short-range wireless communication module to connect to the plurality of client electronic devices 200, 300, and 400. The connecting interface 140 can also include communication modules that can be connected to an Internet server. For example, the connecting interface 140 can include a LAN port and/or a wireless LAN card. If the connecting interface 140 additionally includes the LAN port and the wireless LAN card, the host electronic device 100 can be connected to the Internet server.

The memory 150 can permanently or temporarily store programs required to operate the host electronic device 100, drivers to control the plurality of client electronic devices 200, 300 and 400, and application programs for checking properties of files stored in the client electronic devices 200, 300 and 400. When the host electronic device 100 transmits and receives data to and from the client electronic devices 200, 300, and 400, the memory 150 may buffer the data according to a predetermined size. The memory 150 may be divided into a program area and a data area.

The program area may store an operating system (OS) for booting the host electronic device 100 and drivers for controlling connectivity and operations of the plurality of client electronic devices 200, 300 and 400. The host electronic device 100 can also store a variety of application programs, such as, for example, file reproducing programs related to music, movies, documents, games, and/or photographs. The program area may also store a program for storing and managing files, a program for managing remaining battery capacity, and a program for selecting and reproducing a file list. The host electronic device 100 may provide the respective functions using corresponding application programs under the control of the controller 160 in response to a user's request.

The data area may store data generated as the host electronic device 100 and the client electronic devices 200, 300, and 400 are operated. For example, the data area can store information regarding file storage states, remaining battery capacity states, and/or file lists transmitted from the client electronic devices 200, 300, and 400. The data area may use history information regarding a reproduced file, a reproduced time of the reproduced file, and a reproducing client electronic device, associated with the client electronic devices 200, 300, and 400. For example, the data area may generate first, second, and third use history information corresponding to the client electronic devices 200, 300, and 400, respectively, and may store and update the first, second, and third use history information according to the control of the controller 160.

The controller 160 may control signal flows among the elements in the host electronic device 100 and may generate control signals for controlling operations of the client electronic devices 200, 300, and 400. The controller 160 may manage file storage states, remaining battery capacity, and file reproduction.

To manage file storage states, if a particular client electronic device 200, 300, or 400 is connected to the host electronic device 100, the controller 160 may request information regarding a file storage state from the connected client electronic device 200, 300, or 400. After receiving the file storage state information, the controller 160 may control the memory 150 to store the file storage state information. The controller 160 may repeat the process with respect to other client electronic devices, and may collect information regarding file storage states of the client electronic devices 200, 300, and 400. The controller 160 may map the file storage state information to two- or three-dimensional geometric diagrams and then output the geometric diagrams.

Next, according to a touch event input by the user, the controller 160 may move or copy files of the particular client electronic device 200, 300, or 400 to another client electronic device or may delete the files. To show which file is moved, copied, or deleted, if a corresponding file is selected, the controller 160 can output detailed information regarding the corresponding file. The controller 160 can also perform a control operation to display all states indicating which files are stored in which client electronic devices 200, 300, and 400 based on the information regarding file storage states. Accordingly, the controller 160 may manage current states of files stored in the client electronic devices 200, 300, and 400. Based on the file storage states, the controller 160 can further move and copy files, and delete unnecessary files.

To manage remaining battery capacity, if the plurality of client electronic devices 200, 300, and 400 are connected to the host electronic device 100 via the connecting interface unit 140, the controller 160 may request information regarding remaining battery capacities from the plurality of client electronic devices 200, 300, and 400. The controller 160 may compare pieces of information regarding remaining battery capacities with each other, and may determine the recharge priority order with respect to the client electronic devices 200, 300, and 400.

For example, if the first, second, and third client electronic devices 200, 300, and 400 have remaining battery capacities of ¾, ½, and ¼, respectively, with respect to full battery capacities, the controller 160 may perform a control operation so that electric power can be first supplied to recharge the battery of the third client electronic device 400.

In some cases, the controller 160 can also perform a control operation so that the batteries of the client electronic devices 200, 300, and 400 can be recharged according to a preset priority order, irrespective of information regarding remaining battery capacities. For example, if the first, second, and third client electronic devices 200, 300, and 400 have the first, second, and third orders of priority, respectively, despite the first, second, and third client electronic devices 200, 300, and 400 having remaining battery capacities of ¾, ½, and ¼, respectively, the battery of the first client electronic device may still be recharged first. After completely recharging the battery of the first client electronic device 200, the battery of the second client electronic device 300 may then be recharged, and subsequently, the battery of the third client electronic device 400. The battery recharging operation may be performed as described above.

In some cases, the controller 160 may recharge batteries according to information regarding remaining battery capacities, the recharge priority order, or any other suitable conditions. For example, if the remaining battery capacity of the batteries of the client electronic devices 200, 300, and 400 is greater than ½ of the total battery capacity of each client electronic device 200, 300, and 400, the controller 160 can control the power supply 130 so that a battery recharging operation is not performed. In some cases, if the first and second client electronic devices 200 and 300 have remaining battery capacities greater than the remaining battery capacity (e.g., less than a half) of the third client electronic device 400, the controller 160 may first recharge the battery of the third client electronic device 400. The controller 160 can also control the display unit 120 to display information regarding the remaining battery capacities and information regarding battery charge states.

To manage file reproduction, if the plurality of client electronic devices 200, 300, and 400 are connected to the host electronic device 100 via the connecting interface unit 140, the controller 160 may request file lists from the plurality of client electronic devices 200, 300, and 400. After receiving the file lists, the controller 160 may control the display unit 120 to display the received file lists. The controller 160 can also display graphical representations (e.g., icons) corresponding to the client electronic devices 200, 300, and 400 and graphical representations (e.g., icons) corresponding to the respective lists of files. After that, the controller 160 may ascertain which file is selected according to an input signal received from the input unit 110 or a touch screen.

If files to be reproduced are selected, the controller 160 may determine the remaining battery capacity of a corresponding client electronic device 200, 300, or 400 storing the selected files. If the remaining battery capacity of the client electronic device 200, 300, or 400 is less than a preset level, the controller 160 may determine whether the selected file is stored in any other client electronic devices. If the controller 160 determines that another client electronic device has also stored the selected file and a remaining battery capacity of the another client electronic device is greater than a preset level, the controller 160 can control the another client electronic device to reproduce the selected file. If, however, the controller 160 ascertains that the another client electronic device has stored the selected file but has a remaining battery capacity less than the preset level, the host electronic device 100 may not reproduce the selected file, and may display a pop-up message indicating ‘remaining battery capacity low’ on the display unit 120, or may output an alarm sound.

If the controller 160 does not search for a corresponding file from the plurality of client electronic devices 200, 300, and 400 connected to the connecting interface unit 140, the controller 160 can access an Internet server and then download the file. The host electronic device 100 may include an RF communication unit that can access the Internet server. If the host electronic device 100 does not include an RF communication unit, the controller 160 can determine whether a client electronic device 200, 300, or 400 connected to the connecting interface 140 can access the Internet server through a communication module. For example, if the controller 160 determines that the first client electronic device 200 has a communication module, the controller 160 may operate the communication module to access the Internet server and may perform a control operation so that web pages from the Internet server can be displayed on the display unit 120, and a file may be retrieved from the Internet.

The controller 160 may transmit, to the Internet server via the communication module of the first client electronic device 200, a message for requesting a particular file published on a web page according to a user's request. The controller 160 may then download the file. The downloaded file may be temporarily stored in the first client electronic device 200 and then reproduced. The downloaded file can also be reproduced by a client electronic device with sufficient remaining battery capacity or by a user-designated client electronic device. The controller 160 may perform a control operation in such a way that the downloaded file can be stored in the first client electronic device 200 or in a memory of another client electronic device 300 or 400 according to a user's selection. The controller 160 can also perform a control operation to store the downloaded file in a client electronic device 200, 300, or 400 with the largest remaining battery capacity.

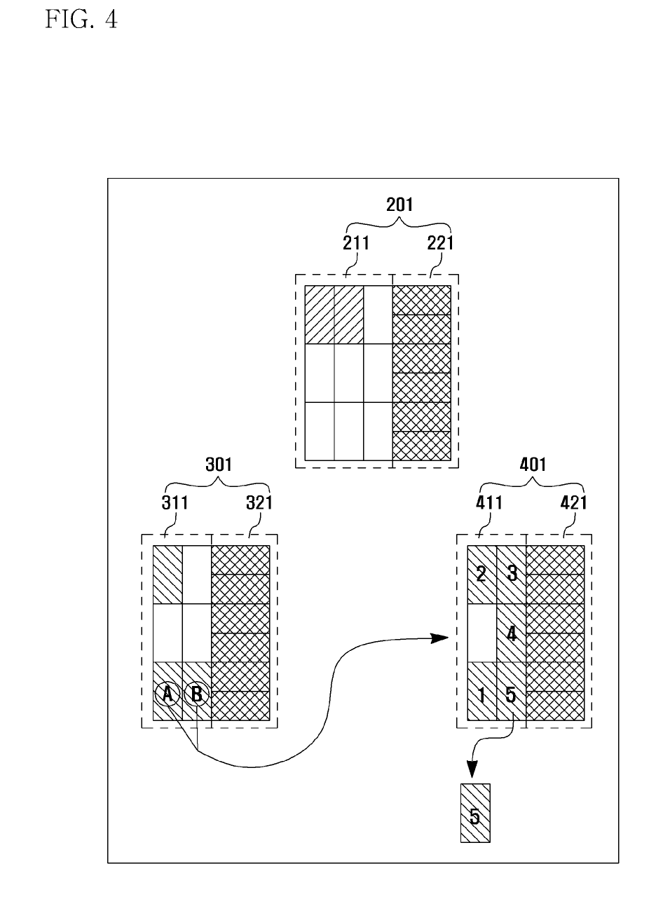

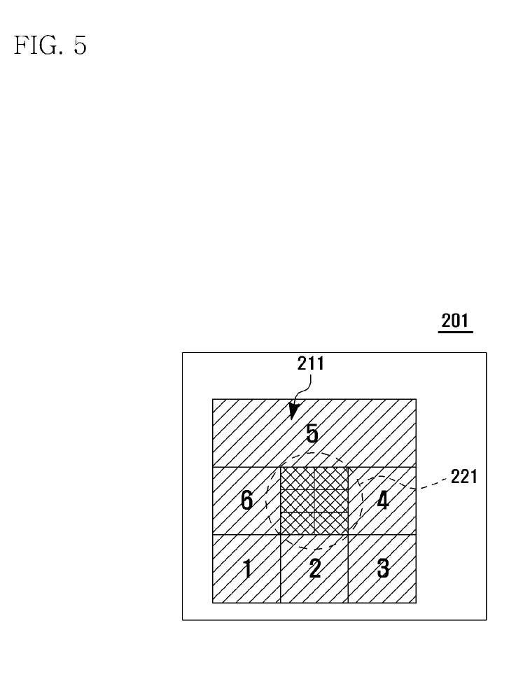

As described above, the host electronic device 100 can integrally and intuitively manage file storage, remaining battery capacity, and file reproduction in a variety of client electronic devices connected to the connecting interface unit 140. In the following description, the screen interface displayed on the display unit 120 of the host electronic device 100 is described in detail with reference to FIG. 3, FIG. 4, and FIG. 5.

FIG. 3, FIG. 4, and FIG. 5 show examples of a screen interface for file storage management according to exemplary embodiments of the invention.

FIG. 3 is a view illustrating a screen interface that displays information regarding file storage states received from a plurality of client electronic devices 200, 300, and 400, according to exemplary embodiments of the invention. The screen interface for file storage management will be explained using a two-dimensional block as shown in FIG. 3, FIG. 4, and FIG. 5. It, however, should be understood that exemplary embodiments of the invention are not limited to two-dimensional blocks, and that the file storage management states can also be illustrated by other suitable diagrams, for example, a three-dimensional geometrical diagram.

Referring to FIG. 3, the display unit 120 may display file storage states 201, 301, and 401 of memories in the first, second, and third client electronic devices 200, 300, and 400, respectively, in a two-dimensional geometrical diagram. More specifically, the memory (indicated by file storage state 201) in the first client electronic device 200 may be divided into seven small-size sections and one medium-size section. The seven small-size sections store files (i.e., data) and the medium-size section remains empty. The memory (indicated by file storage state 301) in the second client electronic device 300 may be divided into two small-size sections, one medium-size section, and two different-shaped large-size sections. The two small-size sections, one medium-size section, and one large-size section store data, but the other large-size section remains empty. The memory (indicated by file storage state 401) in the third client electronic device 400 may be divided into 12 small-size sections, eight of which store data. Each of the file storage states 201, 301, and 401 of the first, second and third client electronic devices 200, 300, and 400 may indicate that files having correlation are subsequently arrayed in the memory. For example, regarding the file storage state 401 of the third client electronic device 400, three small-size sections in the first row (from top) store files in a small-size file unit (i.e., three small files that originally comprised one large file). Regarding the file storage state 301 of the second client electronic device 300, one large-size section in the first row stores one large file. Although the size of files stored in the memory is divided into small, medium, and large, it should be understood that the file size can be of any suitable size and can be additionally sub-divided. Accordingly, the file storage state can be more variously expressed.

While the file storage states 201, 301, and 401 of the client electronic devices 200, 300, and 400 are displayed on the display unit 120, the controller 160 can alter the file storage states 201, 301, and 401 according to a signal input to the input unit 110. For example, if a touch event occurs on the display unit 120, with respect to the file storage state 401 of the third client electronic device 400, the controller 160 may alter the locations of the files according to the input touch event. For example, with respect to the file storage state 401 of the third client electronic device 400, a drag event may occur to move the small-size section, which is located in the middle of the second row, to the empty section located in the middle of the third row. The controller 160 may then perform a control operation in such a way as to move the small-size section storing data, in the second row, to the empty small-size section in the third row. Accordingly, in the file storage state 401 of the third client electronic device 400, the three small-size sections in the second row may subsequently be empty. The controller 160 can thus perform a control operation to move selected data to an empty space according to a touch event, and can control the display unit 120 to display the process, thereby intuitively and properly performing file management.

If a touch event indicates selection of a section “A” including stored data in the memory corresponding to the file storage state 301 of the second client electronic device 300, the user may drag and move the data to the medium-size section in the memory corresponding to the file storage state 201 of the first client electronic device 200, the controller 160 may control the memory of the second client electronic device 300 to empty the section “A” and the memory of the first client electronic device 200 to store the data moved from section “A” in the medium-size section of the memory corresponding to the file storage state 201. The data may be moved by blocks. In the process of moving data blocks, the controller 160 may output movement states of data blocks on the display unit 120 to display data movement from one client electronic device to another.

If a particular data block is selected, the controller 160 may control the display unit 120 to display detailed information regarding the selected data block on a side of the display unit 120. The detailed information may include a file attribute, such as, for example, a file name, a file size, and/or a file generated date. Therefore, a user can clearly identify data movement between client electronic devices 200, 300, and 400. The controller 160 can control the display unit 120 to display all the file attributes of the respective data blocks stored in the memories with respect to the file storage states 201, 301, and 401. The controller 160 can also display data blocks organized in an outline or according to certain correlations and features, such as, color, so that the blocks and corresponding files can be easily identified. File organization can be set according to a user's setting. For example, photograph files (e.g., images) can be organized according to, for example, the dates the photograph files were obtained and/or last modified. In another example, music files can be organized according to, for example, singers' names or album titles. The controller 160 can receive information regarding file attributes from the respective client electronic devices 200, 300, and 400 to support file organization, and can process the received information based on criteria (e.g., dates, singers) set by the user.

In the screen interface for file storage management, data blocks showing the file storage states 201, 301, and 401 of the respective client electronic devices 200, 300, and 400 can be displayed in different colors to easily distinguish the client electronic devices 200, 300, and 400. For example, the file storage states 201, 301, and 401 of the first, second, and third client electronic devices 200, 300, and 400 can be displayed in blue, red, and yellow colors, respectively. Data blocks of the respective client electronic devices 200, 300, and 400 can also be displayed in the same color as the respective client electronic devices 200, 300, and 400. If a data block is moved from the memory of one client electronic device to the memory of another client electronic device, the moved data block can retain its initial color (or a color in a previous stage) in the memory of the another client electronic device. Therefore, the user may identify the colors of moved data blocks and determine where the moved data blocks are moved from. In some cases, the moved data block may change its color to the color of the data blocks of the client electronic devices 200, 300, or 400 the data block has been moved to.

After the data blocks have been moved and file management has been completed, if a signal for terminating file storage and management job is input, the data blocks stored in the memories of the respective client electronic devices 200, 300, and 400 may be unified and displayed to match the colors of the client electronic devices 200, 300, and 400 the blocks are located in. That is, the data blocks may keep their original colors while they are moved during the process of file storage movement, so that the user can easily track the movement of data blocks. When the file storage management job has been completed, the colors of the data blocks are unified to match the colors of the client electronic devices 200, 300, and 400 the data blocks are in, so that the user can easily perform another file storage management job.

Although the memories of the client electronic devices 200, 300, and 400 and sections or data blocks arrayed therein were explained in a two-dimensional geometrical diagram, it should be understood that exemplary embodiments of the invention are not limited thereto. For example, the memories of the client electronic devices 200, 300, and 400 and sections or data blocks arrayed therein can also be explained in a three-dimensional geometrical diagram. Similarly, although the memories of the client electronic devices 200, 300, and 400 and sections or data blocks arrayed therein were explained using a rectangular diagram, it should be understood that exemplary embodiments of the invention are not limited thereto. For example, the memories of the client electronic devices 200, 300, and 400 and sections or data blocks arrayed therein can also be explained using a circle, a triangle, a sphere, a triangular pyramid, a hexagon, and/or a rhombus. In addition, the empty spaces in the diagram corresponding to the memory, other than the data blocks, can be displayed with the same geometrical diagrams as corresponding data blocks in a dotted line, a shade, or colors different from those of data blocks, such as a transparent color or a white color. It will be easily appreciated that these geometric diagrams can be configured by a host electronic device engineer or by a user selection. To support the user's selection, the host electronic device 100 can display geometric diagrams according to client electronic devices 200, 300, and 400 on a screen of the display unit 120.

FIG. 4 shows a screen interface of a file storage state according to exemplary embodiments of the invention.

As shown in FIG. 4, each of the memories corresponding to the file storage states 201, 301, and 401 of the first, second, and third client electronic devices 200, 300, and 400 can be divided into a protection area and a non-protection area. The protection area may refer to an area where files protected from deletion are stored. For example, if a user applies deletion prevention to a file, the file may be stored in the protection area. The non-protection area may refer to an area where files that are not protected from deletion are stored.

Referring to the screen interface shown in FIG. 4, the memory corresponding to the file storage state 201 in the first client electronic device 200 may be divided into a first protection area 221 and a first non-protection area 211. The first protection area 221 may be sub-divided into six small-size sections all of which store data. The first non-protection area 211 may be sub-divided into nine small-size sections, two of which store data and seven of which are in an empty state. Similarly, the memory corresponding to the file storage state 301 in the second electronic device 300 may be divided into a second protection area 321 and a second non-protection area 311. The second protection area 321 may be sub-divided into six small-size sections all of which store data. The second non-protection area 311 may be also sub-divided into six small-size sections, three of which store data. Two small-size sections store data “A” and “B.” Additionally, the memory corresponding to the file storage state 401 in the third electronic device 400 may be divided into a third protection area 421 and a third non-protection area 411. The third protection area 421 may be sub-divided into six small-size sections all of which store data. The third non-protection area 411 may also be sub-divided into six small-size sections, five of which store data.

As shown in FIG. 4, when data blocks in the sections “A” and “B” stored in the memory corresponding to the file storage state 301 in the second client electronic device 300 are intended to be moved to the memory corresponding to the file storage state 401 in the third client electronic device 400, the memory corresponding to the file storage state 401 may require additional operations since the memory corresponding to the file storage state 401 only has one empty small-size section. If data blocks in the sections “A” and “B” are intended to be moved to the memory of the third client electronic device 400, the controller 160 may output a pop-up message indicating that all of the data blocks cannot be moved. When the controller 160 moves the data blocks in the sections “A” and “B” to the memory of the third client electronic device 400, the controller 160 may store one data block in the small-size empty section of the memory of the third client electronic device 400, delete a particular data block stored in the third non-protection area 411, and then store the remaining data block in the emptied section of the third non-protection area 411. The controller 160 may perform deletion of data blocks, according to a stored order of files or the frequency of use of the stored files. For example, if the third non-protection area 411 stores five data blocks, and data block “5” is the oldest one or has the lowest frequency of use, the controller 160 may delete data block “5” from the third non-protection area 411, and may store a data block moved from a section of the memory of the second client electronic device 300 to an empty section of the third non-protection area 411. When a touch event occurs to move other data blocks from the first or second client electronic devices 200 and 300 to the third client electronic device 400, the controller 160 may delete data blocks stored in the third client electronic device 400 and may then store the data blocks, moved from the first or second client electronic devices 200 and 300, in an emptied section of the third client electronic device 400. When data block deletion is performed, only the files in the non-protection area may be deleted.

A data block copy process can also be performed. For example, a touch event may occur to copy a particular data block. An input signal may, for example, be generated by twice touching the data block in the section “A” of the memory corresponding to the file storage state 301 in the second client electronic device 300 to drag and move the data block in the section “A” to an empty small-size section of the memory corresponding to the file storage state 401 in the third client electronic device 400. The controller 160 may keep the data block in section “A” of the memory of the second client electronic device 300, and may store a copy of the data block in section “A” in the small-size section of the memory of the third client electronic device 400, thereby completing the data block copy process. It should be understood that the touch event for the copying operation may be variously set according to a designer or user's setting. If sections of a memory of a client electronic device need to be emptied to allow a data block to be copied, then a data block deletion process as described above may be used.

FIG. 5 shows a screen interface of a file storage state in a client electronic device according to exemplary embodiments of the invention.

Referring to FIG. 5, a file storage state 201 corresponding to a memory of the first client electronic device 200 may include a first protection area 221 in a center portion of the file storage state 201. The periphery of the first protection area 221 may be a first non-protection area 211. The first protection area 221 may include six small-size sections that store data blocks. The first non-protection area 211 may store additional data blocks. As described above, a priority order can be allocated to the data blocks according to a period of time for storing data blocks or a frequency of use of the respective data blocks. For example, if a data block is intended to be moved or copied from another client electronic device to the memory of the first client electronic device 200, the controller 160 may delete the data block stored in section ‘6’ that is the largest number of the six sections in the first non-protection area 211, and may then store the moved or copied data block in the empty section ‘6.’ In addition, if a moved or copied data block is so large that it can be stored in a plurality of sections, for example, sections ‘5’ and ‘6,’ the controller 160 may delete data blocks in sections ‘5’ and ‘6’ and may then store the moved or copied data block in the empty sections ‘5’ and ‘6.’ After storing the data blocks, the controller 160 may change the priority order for the stored data blocks according to, for example, a period of time for storing data blocks.

As described above, the data blocks stored in a protection area may not be replaced with new data blocks transmitted from the other client electronic devices when the new data blocks are being stored. However data blocks stored in the protection area can be moved or copied to other client electronic devices. For example, if a user selects a data block stored in a protection area and moves or copies it to another client electronic device, the controller 160, as described above, may store the data block in an empty section of the other client electronic device, or the controller 160 may delete one of the data blocks stored in the non-protection area of the another client electronic device and may then store the data block in the empty section. If the data block, moved or copied from the protection area, is set to keep its deletion protection setting, the controller 160 can change the corresponding section of the non-protection area into the protection area of the another client electronic device. To make this change, the controller 160 may transmit a control signal requesting deletion protection of the data blocks stored in the another client electronic device. If the data block is not set to keep a deletion protection setting, the controller 160 can perform a control operation so that the data block, even though initially stored in a protection area, may be subsequently stored in a non-protection area without a deletion protection setting.

As described above with regard to FIG. 3, file storage states 201, 301, and 401 of the client electronic devices 200, 300, and 400, shown in FIGS. 4 and 5, can be displayed in colors so that they can be distinguished according to the client electronic devices 200, 300, and 400. Furthermore, data blocks indicating the respective file storage states 201, 301, and 401 can also be displayed in the same colors by the client electronic devices 200, 300, and 400. For example, during movement of the data block, the data blocks may keep their original colors before being moved.

Furthermore, although sections of the memories of the client electronic devices 200. 300, and 400 are explained in such a way to correspond to file size, exemplary embodiments of the invention are not limited thereto. For example, although two files may have the same image, the two files may differ in terms of file size. Therefore, in the following description, it will be appreciated that file sizes corresponding to sections classified into small, medium, and large sizes are normalized within a certain range in order to clearly describe exemplary embodiments of the invention. Additionally, it should be understood that the same-sized data block may correspond to different sized files. Therefore, when data blocks are moved from one client electronic device to another client electronic device, the host electronic device 100 can detect whether data blocks can be moved.

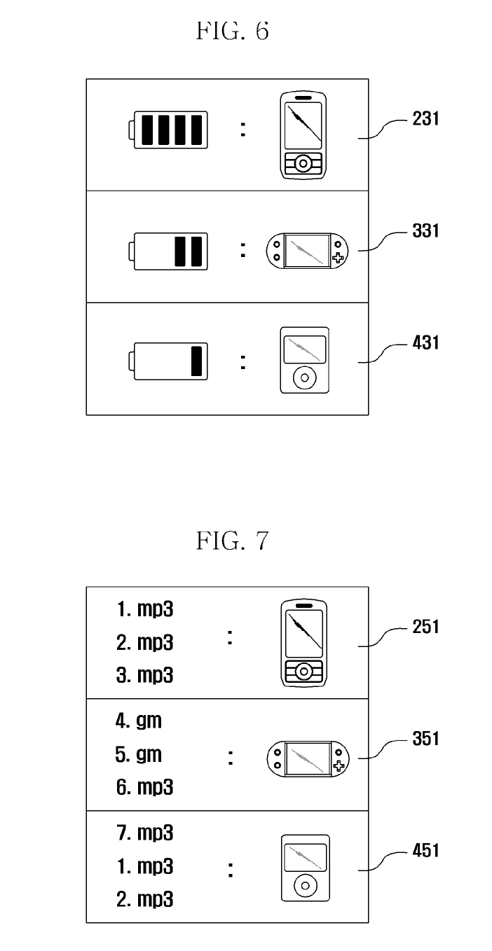

FIG. 6 shows a display unit of a host electronic device displaying states of a remaining battery capacity of each client electronic device according to exemplary embodiments of the invention.

Referring to FIG. 6, the display unit 120 of the host electronic device 100 may display images of remaining battery capacities of the first, second and third client electronic devices 200, 300, and 400 in three respective rows 231, 331, and 431. When a plurality of client electronic devices 200, 300, and 400 are connected to the host electronic device 100 via the connecting interface 140, the controller 160 of the host electronic device 100 may request information regarding remaining battery capacities of the client electronic devices 200, 300, and 400, and may then display images corresponding to the received remaining battery capacities on the display unit 120. Through the images of remaining battery capacities, a user may determine the energy levels of batteries of the respective client electronic devices 200, 300, and 400. As an example, if the client electronic devices 200, 300, and 400 receive a signal requesting information on remaining battery capacity from the host electronic device 100, the client electronic devices 200, 300, and 400 may generate remaining battery capacity information, and may then transmit the remaining battery capacity information to the host electronic device 100.

The display unit 120 can display remaining battery capacities of the client electronic devices 200, 300, and 400 using graphical representations such as, for example, battery icons. The battery icons may represent battery levels using a plurality of bars. The number of bars may indicate the remaining battery capacity. For example, the greater the number of bars, the greater the remaining batter capacity may be. The lower the number of bars, the lower the remaining batter capacity may be.

The client electronic devices 200, 300, and 400 may utilize their respective batteries at different rates according to their respective characteristics. For example, a client electronic device, such as an MP3 player, may consume its battery at a different rate than another client electronic device, such as a PSP. The exact available time for operating the client electronic devices 200, 300, and 400 may not be determined based on the images of the remaining battery capacity displayed on the display unit 120. Accordingly, when the controller 160 requests information regarding remaining battery capacities, the controller 160 may also request information regarding a ratio of remaining batter capacity to total battery capacity, and a remaining time for operating the client electronic devices 200, 300, and 400 with respect to the remaining battery capacities. The client electronic devices 200, 300, and 400 can transmit information regarding the ratio of remaining battery capacity to the total battery capacity, and information regarding respective remaining operating time to the controller 160 of the host electronic device 100. The controller 160 may control the display unit 120 to display information regarding the remaining operating time of the respective client electronic devices 200, 300, and 400. Information regarding the remaining operating time may include information customized for certain characteristics or operations of the respective client electronic devices 200, 300, and 400. For example, a PSP electronic device may not require a function for operating a standby screen since the PSP electronic device may be mainly used to reproduce a game or files. Therefore, the remaining battery capacity of the PSP electronic device may be proportional to the extra time available to operate the PSP. In case of a mobile communication electronic device a remaining battery capacity may, for example, differ between a call standby mode and a call mode. The mobile communication electronic device may transmit remaining time operation information to the controller 160 of the host electronic device 100, where the remaining time operation information includes information regarding a ratio of the remaining battery capacity to the total battery capacity, information regarding battery available time in a call standby mode, and information regarding battery available time in a call mode. The display unit 120 may display images of the remaining battery capacities and icons or texts corresponding to the client electronic devices 200, 300, and 400 in the corresponding rows 231, 331, and 431, respectively, so that the user can easily recognize the remaining battery capacities of the client electronic devices 200, 300, and 400.

After the user has checked the information regarding the respective remaining battery capacities displayed on the display unit 120, the user can directly command the controller 160 to recharge a battery of a client electronic device 200, 300, or 400. For example, when the controller 160 receives an input signal for requesting a battery recharge from the user, the controller 160 may control the power supply to first recharge the battery of a corresponding client electronic device 200, 300, or 400 according to the input signal. However, if the controller 160 does not receive any specific command from the user, the controller 160 may control the display unit 120 to display a pop-up message indicating that battery recharge will be performed according to a preset priority order, and may recharge a corresponding battery of a client electronic device 200, 300, or 400 while performing an alarm operation indicating that the corresponding battery is being recharged.

The controller 160 can also determine the battery recharge priority order based on stored use history information regarding the client electronic devices 200, 300, and 400. For example, if the memory 150 has stored use history information indicating that a user mainly uses the first client electronic device 200 on Mondays and the second client electronic device 300 on Tuesdays, the controller 160 may determine the current day and perform control operations to first recharge the battery of the client electronic device that is mainly used on the determined day. During the recharging process, the controller 160 can also recharge a battery according to a preset condition, for example, a 100% full recharge or 80% of a full recharge. The use history information may include, for example, time, date, and the day (e.g., Monday, Tuesday) of a week.

The controller 160 may detect the power capacity of the power supply 130 in the host electronic device 100, and may control the display unit 120 to display the remaining capacity of the power supply 130. If the power supply 130 is an independent power supply (e.g., a battery having limited power capacity because it is not connected to an electric outlet), the controller 160 can provide information regarding how much the battery of the client electronic devices 200, 300, and 400 can be recharged based on the remaining capacity of the power supply 130. For example, the controller 160 may detect the remaining battery capacities of the batteries of the client electronic devices that are selected according to a preset priority order or according to a user's request, and may generate information regarding how many and how much the batteries of the client electronic devices 200, 300, and 400 can be recharged. The controller 160 may also generate information regarding what priority order batteries of the client electronic devices 200, 300, and 400 can be recharged in according to the capacity of the power supply 130 of the host electronic device 100, and may provide the generated information to the user.

If the controller 160 detects the remaining battery capacities of the client electronic devices 200, 300, and 400 and determines that all the batteries of the client electronic devices 200, 300, and 400 cannot be fully recharged by the remaining capacity of the power supply 130 of the host electronic device 100, the controller 160 may perform a battery recharge according to a preset condition. For example, if 200 mW is required to recharge the batteries of three client electronic devices 200, 300, and 400, but, the remaining capacity of the power supply 130 is 150 mw, the controller 160 may subtract the minimum electric power for operating the host electronic device 100 from the remaining capacity of the power supply 130 and evenly recharge the batteries of the client electronic devices 200, 300, and 400 using the subtracted remaining capacity of the power supply 130. If the user inputs a touch event or an input signal to the input unit 110 for designating a particular client electronic device and requests a full recharge for a battery of the designated client electronic device, the controller 160 may perform a control operation to first recharge the battery of the designated client electronic device. After completing recharge of the designated client electronic device, the controller 160 may not recharge the remaining client electronic devices. For example, in some cases, if a user requests a full-recharge for a particular client electronic device, the request for the particular client electronic device may indicate that user preferentially and more often uses the particular client electronic device with respect to the other client electronic devices. Accordingly, the controller 160 may recharge the particular client electronic device, and may maintain the remaining capacity of the power supply 130 to make provisions for the recharge of the particular client electronic device in future.

FIG. 7 shows a display unit of a host electronic device displaying a list of files of each client electronic device according to exemplary embodiments of the invention.

Referring to FIG. 7, the display unit 120 of the host electronic device 100 may display lists of files of the first, second, and third client electronic devices 200, 300, and 400 in three rows 251, 351, and 451, respectively. When a plurality of client electronic devices 200, 300, and 400 are connected to the host electronic device 100 via the connecting interface 140, the controller 160 of the host electronic device 100 may request, and subsequently receive, information regarding a list of files from the respective client electronic devices 200, 300, and 400, thereby collecting the lists of files. The host electronic device 100 may display the collected lists of files on the display unit 120 under the control of the controller 160.

For example, when the client electronic devices 200, 300, and 400 receive a signal for requesting information regarding a list of files from the host electronic device 100, the client electronic devices 200, 300, and 400 may collect information regarding files stored in their respective memories, and may transmit the information to the host electronic device 100. For example, as shown in FIG. 7, the host electronic device 100 may display 3 files (i.e., 1.mp3, 2.mp3, and 3.mp3) in a list of files associated with the first client electronic device 200, 3 files (i.e., 4.gm, 5.gm, and 6.mp3) in a list of files associated with the second client electronic device 300, and 3 files (i.e., 7.mp3, 1.mp3, and 2.mp3) in a list of files associated with the third client electronic device 400. The lists of files may be displayed in corresponding rows 251, 351, and 451 on the display unit 120 with corresponding client electronic devices 200, 300, and 400, which may be displayed using graphical representations (e.g., icons) or texts.

When the controller 160 receives a signal for selecting a particular file from the input unit 110 or touch screen, the controller 160 may check the remaining battery capacity of the client electronic device that stores the selected file. If the controller 160 determines that the remaining battery capacity of the client electronic device is sufficient to process the selected file, the controller 160 may allow the client electronic device to reproduce the selected file. On the contrary, if the controller 160 determines that the remaining battery capacity of the client electronic device is not sufficient to reproduce the selected file, the controller 160 may perform an alarm operation and may check whether the selected file is stored in another client electronic device. When the controller 160 determines that the same file is stored in another client electronic device, the controller may determine the remaining battery capacity of the another client electronic device, and may determine whether the same file can be reproduced using a remaining battery capacity of the another client electronic device. For example, if a user inputs a signal for reproducing a file, 1.mp3 in the first row 251, as shown in FIG. 7, but a remaining battery capacity of the first client electronic device 200 is not sufficient to reproduce the file, 1.mp3, the controller 160 may check whether the file, 1.mp3, is stored in another client electronic device, and may determine that the third client electronic device 400 also stores the file, 1.mp3. Subsequently, the controller 160 may determine the remaining battery capacity of the third client electronic device 400 and may determine that the remaining battery capacity of the third client electronic device 400 is sufficient to reproduce the file, 1.mp3. The controller 160 may then command the third client electronic device 400 to reproduce the file, 1.mp3. If the controller 160 determines that the remaining battery capacity of the third client electronic device 400 is not sufficient to reproduce the file, 1.mp3, the controller 160 may perform an alarm operation indicating that the first and third client electronic devices 200 and 400 need their batteries recharged.

The controller can also support a file search function. If a user intends to search for a particular file, the controller 160 may display a file searching field on the display unit 120. When the user inputs a word(s) into the file searching field, the controller 160 may determine which client electronic device stores the input word. If the controller 160 detects the file requested by the user, the controller 160 may instruct the display unit 120 to display, on the display unit, a graphical representation of the client electronic device having stored the file. When the searched file is reproduced, the controller 160 may perform the processes as described above (i.e., detecting remaining battery capacity, and determining whether the remaining battery capacity is sufficient to reproduce a file).

If the controller 160 determines that the file requested by the user is not registered in the lists of files of the client electronic devices 200, 300, and 400, the controller 160 may instruct the display unit 120 to display a pop-up message indicating that the file does not exist in the lists of files, and may inquire whether the user would like to connect to an Internet server to access the requested file. If the host electronic device 100 has a communication module connectable to the Internet server and the user requests access to the Internet server, the controller 160 may access the Internet sever via the communication module and may search for the requested file. If the host electronic device does not have a communication module, the controller 160 may check the client electronic devices connected to the connecting interface 140 and determines which client electronic device can be connected to the Internet server. After that, the controller 160 may access the Internet server via the communication module of the determined client electronic device. The user may subsequently access, view, and/or download the requested file.

In FIG. 3, FIG. 4, FIG. 5, FIG. 6, and FIG. 7, although information regarding remaining battery capacities and lists of files is described using icons and/or texts, exemplary embodiments of the invention are not limited thereto. For example, when file storage management, remaining battery capacity management, and file reproduction management are performed with respect to at least one or more client electronic devices 200, 300, and 400 connected to the host electronic device 100, the host electronic device 100 can control the display unit 120 to display information from the client electronic devices 200, 300, and 400 using graphic user interface (GUI) elements. Respective client electronic devices 200, 300, and 400 can be displayed using corresponding graphical representations and GUI elements. For example, the client electronic devices 200, 300, and 400 may be displayed in at least one of the same shape, color, position, direction of the GUI element. Therefore, a user of the host electronic device 100 can more intuitively manage the memory, battery, and lists of files of the client electronic devices 200, 300, and 400.

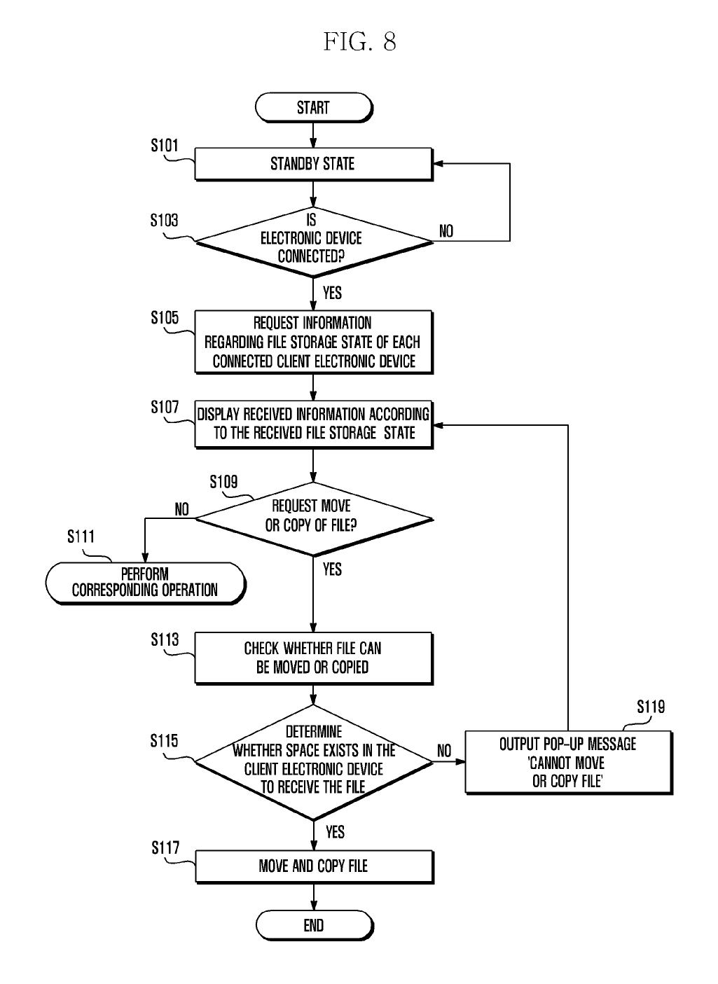

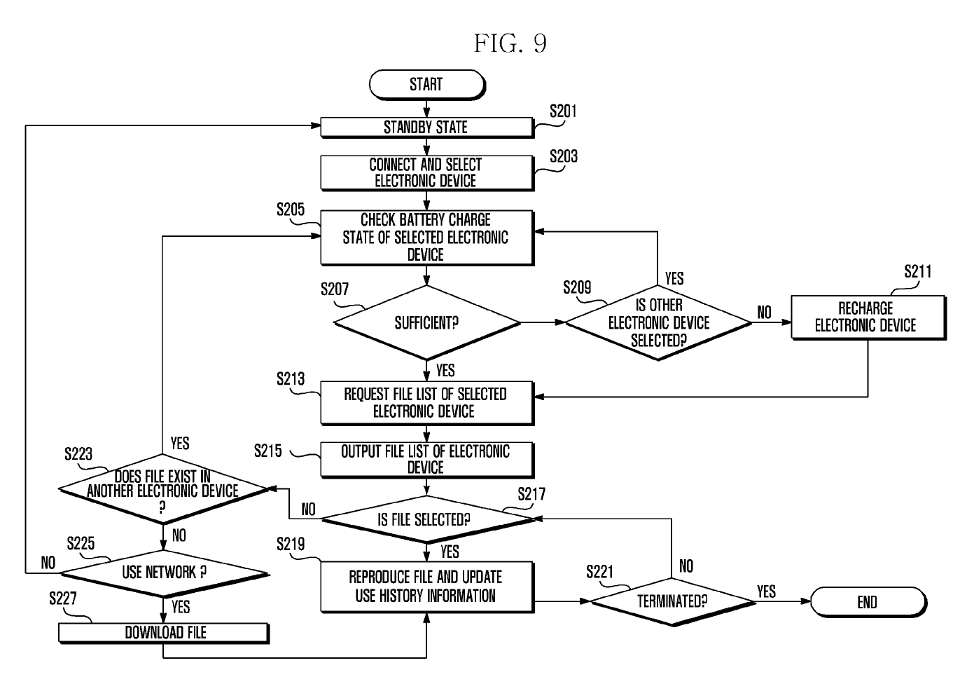

Methods for managing electronic devices according to exemplary embodiments of the invention are explained with reference to FIG. 8 and FIG. 9.

FIG. 8 is a flow chart describing a method for managing file storage states of client electronic devices according to exemplary embodiments of the invention.

Referring to FIG. 8, the host electronic device 100 may be switched on and booted, and may operate in a standby state (S101). The host electronic device 100 may check the connected states of client electronic devices 200, 300, and 400 (S103). For example, the host electronic device 100 may check the connecting interface unit 140 to determine whether client electronic devices 200, 300, and 400 are connected to the host electronic device 100. The connecting interface unit 140 can be implemented using various interfaces, such as, for example, a short-range RF communication module. If the host electronic device 100 determines that the client electronic devices 200, 300, and 400 are not connected to its connecting interface 140 at S101, the host electronic device 100 may return to S101 and may remain in the standby state.

If the host electronic device 100 determines that one or more of the client electronic devices 200, 300, and 400 are connected to the connecting interface 140 at S101, the host electronic device 100 may request information regarding file storage states from the connected client electronic devices (S105). The host electronic device 100 may have corresponding drivers that can control the connected client electronic devices. When the host electronic device 100 receives information regarding file storage states from the connected client electronic devices, the host electronic device 100 may control the display unit 120 to display the received information (S107). The host electronic device 100 may display the information regarding file storage states of the connected client electronic devices in a two- or three-dimensional geometrical diagram, together with detailed information regarding the files stored in the memories of the connected client electronic devices. For example, the host electronic device 100 can display electronic device data blocks, corresponding date of generation, and/or file names, where the data blocks are shown in the information regarding file storage state. If a file is selected, the host electronic device 100 can display detailed information related to the selected file. The host electronic device 100 may also display the data blocks in a two- or three-dimensional geometrical diagram. An empty space in a geometrical diagram corresponding to the memory of a connected client electronic device may be expressed as a geometric diagram shape of a data block. The geometric diagram of the empty space of the memory may be displayed having an outline with a dotted line or having an inner area of the data block being a transparent or white color.

Next, the host electronic device 100 may determine whether a user requests file movement or file copy (S109). The user can request file movement or file copy using the touch screen or the input unit 100 of the host electronic device 100. For example, the user may view information regarding file storage states on the display unit 120, and may directly identify a file to move or copy from one connected client electronic device to another connected client electronic device. As noted above, to move or copy a file between connected client electronic devices, the user can generate a touch event for selecting a file, and a touch event to drag the selected file to indicate a moving or copying of the selected file to the another client electronic device. If the host electronic device 100 determines that the input signal does not correspond to a signal for requesting file movement or file copy at S109, the host electronic device 100 may perform an operation corresponding to the input signal (S111). Examples of the corresponding operation include, but are not limited to, file reproduction management and remaining battery capacity management.

If the host electronic device 100 determines that the input signal corresponds to a signal for requesting file movement or file copy at S109, the host electronic device 100 may check whether the selected file can be moved or copied by checking a state of the memory of the client electronic device to which the selected file is to be moved or copied to (S113). The host electronic device 100 may determine whether a command for file movement or file copy is proper (i.e., whether storage space to which the selected file is moved or copied to exists in the client electronic device) (S115). If the host electronic device 100 determines that the selected file cannot be moved or copied to the storage space in the client electronic device at S115, the host electronic device 100 may output a pop-up message indicating that the file cannot be moved or copied (S119), and may then return to S107.

If the host electronic device 100 determines that the selected file can be moved or copied to the storage space in the client electronic device at S115, the host electronic device 100 may move or copy the file to the designated receiving client electronic device (S117). For example, if the host electronic device 100 moves or copies a first file from a first client electronic device 200 to a second client electronic device 300, the host electronic device 100 may check whether the second client electronic device 300 has space for storing the first file. If the second client electronic device 300 has storage space, the host electronic device 100 may move or copy the first file to the second client electronic device 300. That is, the host electronic device 100 may check whether a non-protection area exists in the second client electronic device 300. If a non-protection area exists in the second client electronic device 300, the host electronic device 100 may, in some cases, delete at least one file stored in the non-protection area of the second client electronic device 300 to secure an empty space for storing the first file.

The host electronic device 100 can also receive a signal for managing file storage states via the input unit 110 or a touch screen. If a variety of files are irregularly stored in the memory of a client electronic device 200, 300, or 400, the host electronic device 100 can perform a control operation to relocate the files in the same memory according to a touch event or input signal.

FIG. 9 is a flow chart describing a method for performing remaining battery capacity management and file reproduction management according to exemplary embodiments of the invention.

Referring to FIG. 9, the host electronic device 100 may be switched on and booted, and may then operate in a standby state (S201). When client electronic devices 200, 300, and 400 are connected to the host electronic device 100, a user may select at least one of the connected client electronic devices (S203). The host electronic device 100 may check a battery charge state of the selected client electronic device (S205). The host electronic device 100 may compare the remaining battery capacity of the selected client electronic device with a preset reference and may determine whether the remaining battery capacity is sufficient (S207). If the host electronic device 100 determines that the remaining battery capacity is not sufficient at S207, the host electronic device 100 may determine whether the user has also selected another client electronic device (S209). If the user has selected another client electronic device, the host electronic device returns to S205. If, however, the user has not selected another client electronic device, the host electronic device 100 may recharge the battery of the currently selected client electronic device using power supply 130 (S211).

If the host electronic device 100 determines that the remaining battery capacity of the selected client electronic device is sufficient at S207, the host electronic device 100 may request a list of files from the selected client electronic device (S213). After that, the host electronic device 100 may output the received list of files (S215).

The host electronic device 100 may then determine whether a particular file in the list of files is selected by the user from the input unit 110 or the touch screen (S217). For example, a user may input, using input unit 110 or the touch screen, a file name to search for a file, and may subsequently select a file. A selection signal may be generated and received by the host electronic device 100 when the user makes a selection of a file. If the host electronic device 100 determines that a file has been selected or searched for using an input word, or a selection signal has been received at S217, the host electronic device 100 may control a corresponding client electronic device to reproduce the selected file and generate or update use history information regarding the selected file according to the reproduction process in the corresponding client electronic device (S219).

The host electronic device 100 may subsequently determine whether a termination signal is input (S221). If the host electronic device determines that a termination signal is not input at S221, the method may return to S217 as described above. If the host electronic device 100 determines that a termination signal is input at S221, the method for performing remaining battery capacity management and file reproduction management may be terminated.

If the host electronic device 100 determines that a file corresponding to a received selection signal does not exist in the list of files of the client electronic device (at S217), the host electronic device 100 may determine whether the file exists in other client electronic devices (S223).

If the host electronic device 100 determines that the file does not exist in other client electronic devices at S223, the host electronic device 100 may determine whether to use a network (S225). If the host electronic device receives an input signal for using a network from the user at S225, the host electronic device 100 may access an Internet server, search for the file, and transmit a file request signal to a corresponding Internet server. The host electronic device 100 may then download the file from the Internet server (S227). After completing the file download, the method may proceed to S219 where the file is reproduced and use history information is updated. The updated use history information may be stored, as a file, in the client electronic device having a communication module that may be connected to the Internet server. The host electronic device 100 can store the downloaded file in a client electronic device according to a preset condition. The host electronic device 100 may then generate a use history with respect to the client electronic device storing the file.

If, at S223, the host electronic device 100 determines that the selected file exists in other client electronic devices, the method may return to and proceed with S205. In S205, the host electronic device 100 may determine whether remaining battery capacity of the other client electronic device is sufficient to reproduce the file. If the remaining battery capacity is sufficient, the host electronic device 100 may reproduce the file. However, if the remaining battery capacity is not sufficient, the host electronic device 100 may recharge the battery of the other client electronic device and may then reproduce the file. The host electronic device 100 may then skip S213, S215, and S217, and branch S209 and S211, as described above, and may proceed to S219 to reproduce the selected file.

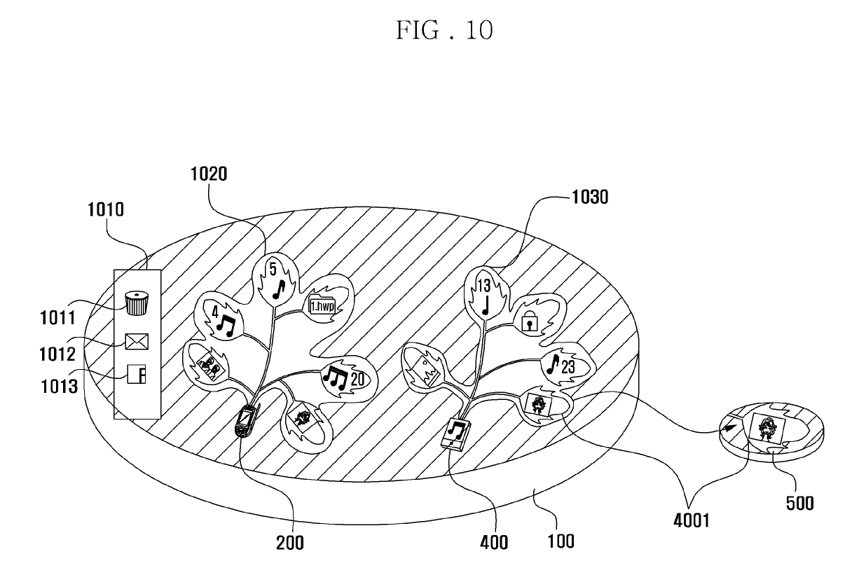

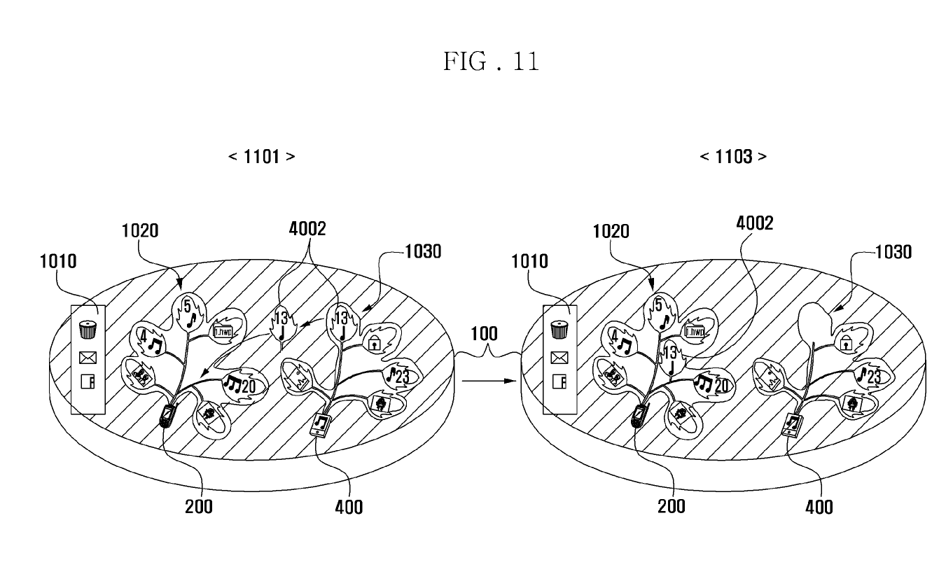

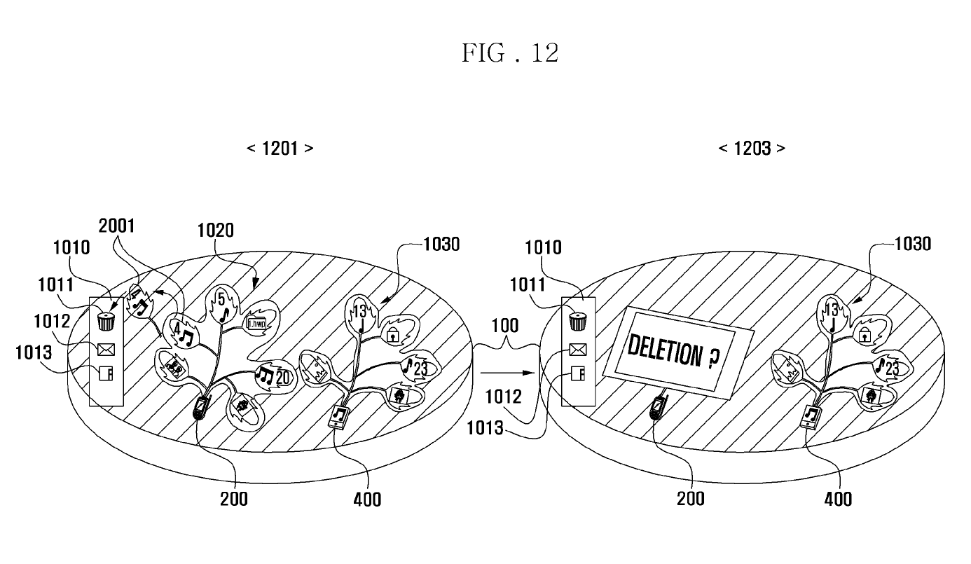

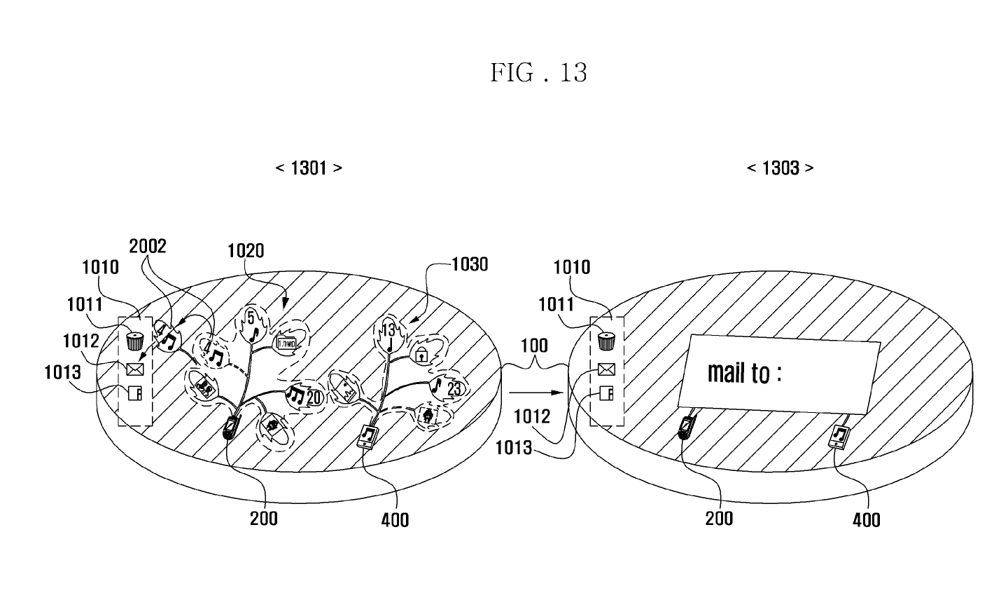

In the following description, a method for operating an electronic device management system is described with reference to FIG. 10, FIG. 11, FIG. 12, and FIG. 13.

FIG. 10 is a view illustrating a first method for operating an electronic device management system according to exemplary embodiments of the invention.

Referring to FIG. 10, the electronic device management system may include a host electronic device 100 and client electronic devices 200, 400, and 500. The client electronic devices 200, 400, and 500 may refer to a portable terminal 200, a file playback device 400, and a file storage device 500.

The host electronic device 100 may include an input unit 110, a display unit 120, a power supply 130, a connecting interface unit 140, a memory 150, and a controller 160, as described above. The host electronic device 100 may further include any suitable device and components, and is not limited to the components noted above. For example, the host electronic device 100 may further include an audio processing unit, a camera module, a broadcast receiving module, and/or a GPS module.

The display unit 120 may be implemented as a touch screen. If an element is arrayed on the display unit 120 of the host electronic device 100, the host electronic device 100 may detect the position of the element. For example, the host electronic device 100 can communicate with client electronic devices 200, 400, and 500 on the display unit 120. In some cases, the host electronic device 100 may be communicating, via the connecting interface unit 140, with client electronic devices 200, 400, and 500 which maybe within a certain distance of the host electronic device 100. For example, if the portable terminal 200 and the file playback device 400 are arrayed on the display unit 120, the host electronic device 100 can establish a communication channel using, for example, compatible short-range communication modules of the host electronic device 100, the portable terminal 200, and the file playback device 400.

If the host electronic device 100 establishes a communication channel with the portable terminal 200 and the file playback device 400, the host electronic device 100 may receive information regarding contents from the portable terminal 200 and the file playback device 400 according to preset schedule information. The preset schedule information may include a list of information to be collected from the portable terminal 200 and a list of information to be collected from the file playback device 400. The preset schedule information may be set/changed by a user of the host electronic device 100, a user of the portable terminal 200, or a user of the file playback device 400. If the host electronic device 100 collects information corresponding to the lists of information from the portable terminal 200 and file playback device 400, the host electronic device 100 may control the display unit 120 to display a user interface based on the collected information. For example, the host electronic device 100 may output, on the display unit 120, a user interface corresponding to the list of information received from the portable terminal 200, so that the user interface may be in the vicinity of an area where the portable terminal 200 is arrayed on the display unit 120. The host electronic device 100 may output, on the display unit 120, a user interface corresponding to the list of information received from the file playback device 400, so that the user interface is in the vicinity of an area where the file playback device 400 is arrayed on the display unit 120. For example, the host electronic device 100 may output a list of information arranged in, for example, a tree-like structure as shown in the display unit 120 in FIG. 10. The list of information may be output to an area in the vicinity of the portable terminal 200 and file playback device 400. The tree-like structure may be displayed so that its leaf graphics show items included in the list of information received from the respective electronic devices 200 and 400. The host electronic device 100 may also output icons for supporting functions related to the management of contents, for example, a recycle bin icon 1011, a message icon 1012, and/or a miscellaneous icon 1013.

The host electronic device 100 may output, on the display unit 120, an icon group 1011 containing the icons described above. If the portable terminal 200 and file playback device 400 are arrayed on a particular portion of the display unit 120, the host electronic device 100 may output an information display group corresponding to the portion of the display unit 120. As shown in FIG. 10, the host electronic device 100 may output, on the display unit 120, the information display groups in the vicinity of the portable terminal 200 and file playback device 400.

Although the information display group is described based on a first information display group 1020 corresponding to the portable terminal 200 and a second information display group 1030 corresponding to the file playback device 400, it should be understood that exemplary embodiments of the invention are not limited to a specific number of information display groups. For example, if the host electronic device 100 communicates with electronic devices 200 and 400 arrayed on the display unit 120 and receives a list of information from the electronic devices 200 and 400, the host electronic device 100 may output one, two, three, or four (e.g., one or more) information display groups corresponding to the list of information on the display unit 120.

The portable terminal 200 may be an electronic device with a mobile communication function. The portable terminal 200 may include a memory for storing a variety of contents and a camera module for capturing images. The portable terminal 200 may download a variety of contents (e.g., images, moving images, text, and/or music files) from a server. The portable terminal 200 can also acquire such contents using its components or via communication with other electronic devices. The portable terminal 200 can store the downloaded or acquired contents in the memory of the portable terminal 200. If the portable terminal 200 is arrayed on a portion of the display unit 120 of the host electronic device 100, the portable terminal 200 may communicate with the host electronic device 100 according to preset schedule information and may transfer a list of information regarding contents stored in the memory of the portable terminal 200 to the host electronic device 100. The list of information stored in the memory of the portable terminal 200 may include, for example, a file name of a particular content, a resized image or a representative image of a particular content, and/or image information corresponding to the property of a particular content. If the list of information stored in the portable terminal 200 is transferred to the host electronic device 100, the list may be displayed on the display unit 120 as an image corresponding to a first information display group 1020. Each of the items contained in the list of information may refer to at least one of the property, image, and file name of a corresponding content, and may be output to the first information display group 1020.

The file playback device 400 may refer to an electronic device with a file playback function. The file playback device 400 may include a memory for storing a variety of contents. The file playback device 400 may play back contents according to a user's choice. Examples of the contents include, but are not limited to, still images, moving images, and audio data. If the file playback device 400 is arrayed at a portion of the display unit 120 of the host electronic device 100, the file playback device 400 may communicate with the host electronic device 100 according to preset schedule information, and may transfer a list of information regarding contents stored in the memory of the file playback device 400 to the host electronic device 100. The list of information stored in the memory of the file playback device 400 may include, but is not limited to, a file name of the content, a thumbnail image or a representative image of the content, and/or an image representing the property of the content. An example of the property of the content is a property for identifying content as photographs, moving images, and/or audio contents. If the list of information stored in the file playback device 400 is transferred to the host electronic device 100, the list of information may be displayed, on the display unit 120, as an image corresponding to a second information display group 1030. Each of the items in the list of information stored in the file playback device 400 may be output to the second information display group 1030 as an image or a file name representing the property associated with the content.

The file storage device 500 may communicate via the connecting interface 140 of the host electronic device 100, may receive contents from the host electronic device 100 or from the portable terminal 200 and the file playback device 400 that are connected to the host electronic device 100, and may store the received contents. The file storage device 500 may include a display unit that can output information regarding the received contents according to settings of the file storage device 500. Examples of the received contents include, but are not limited to, images of contents, file names of contents, and images indicating the property of contents. As shown in FIG. 10, if a touch event is input to move a particular graphic element displayed on the display unit 120 of the host electronic device 100, the file storage device 500 may receive content corresponding to the graphic element and may then store the corresponding content. For example, when the host electronic device 100 outputs the first and second information display groups 1020 and 1030 on the display unit 120, a user may input a motion selecting at least one content (e.g., the first content 4001) from the second information display group 1030, and may drag the first content 4001 in a direction, for example, towards the file storage device 500. The host electronic device 100 may move the first content 4001 to the file storage device 500 according to the input signal (i.e., the touch and drag event that touches and drags the first content 4001 in a direction). The host electronic device 100 may also cut and move, or copy the first content 4001 from the portable terminal 200 or the file playback device 400 according to a feature of the first content 4001. For example, if the first content 4001, for example, a Digital Rights Management (DRM) content, is displayed in the host electronic device 100 and an input signal is generated to move the first content 4001 to the file storage device 500, the first content 4001 may be cut from portable terminal 200 and/or the file playback device 400. If the first content 4001 corresponds to content without the rights to restrict use and an input signal is generated to move the first designated content 4001 to the file storage device 500, the host electronic device 100 can copy the first content 4001 to the file storage device 500 without performing a ‘cut’ operation.

The input signal for moving the first designated content 4001 to the file storage device 500 may correspond to a preset operation, and, in some cases, may include a variety of signals. For example, if the display unit 120 of the host electronic device 100 is implemented with a touch screen, the user can generate an input signal for moving the first content 4001 based on a touch event. The user can also generate an input signal for moving the first content 4001 via an input unit of the host electronic device 100. It should be understood that various types of signals may be used to control and move contents according to the design scheme and/or a user's settings. For example, if the user generates a preset input signal, such as a double tapping motion, for the first content 4001, or if the user selects the first content 4001 and then generates a drag event in a certain shape or direction (e.g., towards the file storage device 500), using a preset motion, such as a touch event, the host electronic device 100 may move the first designated content 4001 to the file storage device 500.

The host electronic device 100 may output a message for moving a file on the display unit 120 in support of the movement of contents. If the user generates an input signal for designating the first content 4001, the host electronic device 100 can output an image, such as an arrow, indicating the drag direction to move the content to the file storage device 500, to one side of the display unit 120. If the file storage device 500 receives the first content 4001 from the host electronic device 100, the file storage device 500 can output the image of the first received content 4001 in the same shape as the image is output on the display unit 120 of the host electronic device 100. In some cases, the file storage device 500 may resize and output an image corresponding to the first content 4001 according to the settings of the display unit of the file storage device 500. In some cases, the file storage device 500 may output the image corresponding to the first content 4001 in another form (e.g., text). To output the image in another form, the file storage device 500 may read information included in the first content 4001 provided by a header of the first content 4001, may select information from the read information according to a preset condition, and may then output the first content 4001 in text form.

FIG. 11 is a view illustrating a second method for operating an electronic device management system including a host electronic device 100 and client electronic devices 200 and 400 connected to the host electronic device 100 according to exemplary embodiments of the invention. The display unit 120 of the host electronic device 100 may be implemented as a touch screen.

Referring to FIG. 11, if the portable terminal 200 and file playback device 400 are arrayed on the display unit 120 of the host electronic device 100, the host electronic device 100 may communicate with the portable terminal 200 and file playback device 400, and may receive information regarding contents included in the portable terminal 200 and file playback device 400. The host electronic device 100 may output, on the display unit 120, first and second information display groups 1020 and 1030 based on the received information. The host electronic device 100 may output the first information display group 1020 in an area in the vicinity of the portable terminal 200. Likewise, the host electronic device 100 may also output the second information display group 1030 in an area in the vicinity of the file playback device 400. In addition, the host electronic device 100 can also output an icon group 1010 on a portion of the display unit 120 where the icon group 1010 contains icons for executing functions, such as deletion, message transmission, and other functions. The other functions may include moving, copying, and/or editing content.

When the host electronic device 100 outputs the first and second information display groups 1020 and 1030 on the display unit 120, the user can select a graphic element corresponding to an item included in one of the groups 1020 and 1030. The user may then move the selected graphic element and a content item corresponding to the graphic element to the other information display group. For example, the user can generate an input signal for selecting second content 4002 in the second information display group 1030. As illustrated by screen 1101 in FIG. 11, the user can select the second content 4002 by touching an area where the second content 4002 is displayed on the display unit 120. The user may then generate an input signal (e.g., a drag event) to move the second content 4002 to the first information display group 1020.

As illustrated by screen 1103 in FIG. 11, the host electronic device 100 can output the graphic element corresponding to second content 4002 at one side of the first display group 1020 on the display unit 120 after completing the move from the second information display group 1030 to the first information display group 1020. The user can move the graphic element corresponding to second content 4002 to a position in the first information display group 1020 corresponding to a position of one of the graphic elements in the first information display group 1020. The first information display group 1020 may combine a graphic element displayed at a region near the area where a graphic element corresponding to the second content 4002 is arrayed. While the processes (e.g., moving, combining) are being performed, the host electronic device 100 can control the movement of content according to a user's input. That is, the host electronic device 100 can move the second content 4002 contained in the file playback device 400 to the portable terminal 200.

The host electronic device 100 can display changes corresponding to the movement of the second content 4002 by, for example, deleting a graphic element corresponding to the second content 4002 from the second information display group 1030. The host electronic device 100 can move the second content 4002 by copying it according to a user's setting and to a property of the second content 4002. For example, if the second content 4002 does not have the rights to restrict use (i.e., is not set to have DRM rights), and is set to be copied, the user can generate an input signal for copying the second content 4002 to the first information display group 1020. Accordingly, the host electronic device 100 may perform a copying operation so that a graphic element corresponding to the second content 4002 can be displayed with the first information display group 1020 and the second information display group 1030.

An input signal to copy the second content 4002 to another information display group may differ from the input signal to move the second content 4002. For example, the input signal to copy the second content 4002 to another information display group may be generated as a touch event by twice tapping a graphic element corresponding to the second content 4002 and then executing a drag event.

FIG. 12 is a view that illustrates a third method for operating an electronic device management system including a host electronic device 100 and client electronic devices 200 and 400 connected to the host electronic device 100, according to exemplary embodiments of the invention. The display unit 120 of the host electronic device 100 may be implemented as a touch screen. An input signal for moving the content contained in a particular information display group may be generated as a user generates a touch event on the display unit 120 of the host electronic device 100. The input signal can also be generated via the input unit 110 of the host electronic device 100.

Referring to FIG. 12, if graphical representations of the portable terminal 200 and file playback device 400 are arrayed on the display unit 120 of the host electronic device 100, the host electronic device 100 may communicate with the portable terminal 200 and file playback device 400, and may receive information regarding contents in the portable terminal 200 and file playback device 400. The host electronic device 100 may output, on the display unit 120, first and second information display groups 1020 and 1030 based on the received information. The host electronic device 100 may output the first information display group 1020 in an area in the vicinity of the portable terminal 200. The host electronic device 100 may also output the second information display group 1030 in an area in the vicinity of the file playback device 400. The host electronic device 100 can also output an icon group 1010 on a portion of the display unit 120. The icon group 1010 may include a recycle bin icon 1011 associated with a deletion function, a message icon 1012 for supporting a message transmission function, and an additional icon 1013 for supporting additional functions.

If the first and second information display groups 1020 and 1030 are output on the display unit 120 of the host electronic device 100, as shown by screen 1201 in FIG. 12, the user may select the third content 2001 in the first information display group 1020 and may move a graphic element corresponding to the third content 2001 to a particular icon in the icon group 1010. If the host electronic device 100 supports a touch screen function, the user may select the third content 2001 by touching a region on the display unit 120 where the graphic element corresponding to the third content 2001 is displayed, and may then drag the graphic element corresponding to the third content 2001 to the icon group 1010. The host electronic device 100 may detect the user's touch event and may move the graphic element corresponding to the third content 2001 to the particular icon in the icon group 1010. In some cases, the user may select the third content 2001 using the input unit 110 of the host electronic device 100, and may then move the graphic element corresponding to the third content 2001 using the direction keys in the input unit 110.

If the graphic element corresponding to the third content 2001 and the third content 2001 need to be deleted from the first information display group 1020 and a client electronic device 200 corresponding to the first information display group 1020, the user may move the graphic element corresponding to the third content 2001 to the recycle bin icon 1011 contained in the icon group 1010. For example, if an image corresponding to the third content 2001 is moved on the display unit 120 and arrayed to overlap the recycle bin icon 1011, the host electronic device 100 may output a pop-up message asking whether to delete the third content 2001 as shown by screen 1203 in FIG. 12. The pop-up message may be output optionally according to a user's settings.

When the user inputs a signal to confirm “Deletion,” the host electronic device 100 may delete the third content 2001 from the first information display group 1020. In some cases, the third content 2001 may be permanently deleted from the portable terminal 200.

FIG. 13 is a view illustrating a fourth method for operating an electronic device management system including a host electronic device 100 and client electronic devices 200 and 400 connected to the host electronic device 100, according to exemplary embodiments of the invention. The display unit 120 of the host electronic device 100 may be implemented using a touch screen.

Referring to FIG. 13, if graphical representations of the portable terminal 200 and file playback device 400 are arrayed on the display unit 120 of the host electronic device 100, the host electronic device 100 may output, on the display unit 120, first and second information display groups 1020 and 1030 based on information regarding contents stored in the portable terminal 200 and file playback device 400. The host electronic device 100 may output the first information display group 1020 in an area in the vicinity of the portable terminal 200. The host electronic device 100 may also output the second information display group 1030 in an area in the vicinity of the file playback device 400. The host electronic device 100 can also output an icon group 1010 on a portion of the display unit 120. The icon group 1010 may include, for example, a recycle bin icon 1011 associated with a deletion function, a message icon 1012 for supporting a message transmission function, an additional icon 1013 for supporting additional functions.

The host electronic device 100 can transmit content in the first information display group 1020 to other electronic device. As illustrated in screen 1301 in FIG. 13, the user may generate an input signal for selecting a content (e.g., the fourth content 2002) from the first information display group 1020, and may then drag and move a graphic element corresponding to the fourth content 2002 to the message icon 1021 in the icon group 1010.

If the graphic element corresponding to the fourth content 2002 contained in the first information display group 1020 is moved and arrayed to overlap the message icon 1012, the host electronic device 100 may output a pop-up window on the display unit 120 indicating execution of a message transmission function. The pop-up window may be used to input a mail address of a recipient to which the fourth content 2002 will be transmitted, as shown by screen 1303 in FIG. 13. The user may then input a mail address to the pop-up window via the input unit 110 and may generate an input signal for transmission. The host electronic device 100 may perform a controlling operation to transmit the fourth content 2002 to the recipient using the input mail address. In some cases, the host electronic device 100 may further include a communication module to communicate with an electronic device associated with the recipient.

In some cases, a user may select a plurality of contents from the first and second information display groups 1020 and 1030 for transmission to a recipient as described above, and the host electronic device 100 may then transmit the selected plurality of contents to the electronic device having a particular mail address. The host electronic device 100 may provide a function for searching for the history of used mail addresses and may output the searched mail addresses in a list on the display unit 120. The user may then conveniently select or input a mail address. The host electronic device 100 may also include a communication interface unit that can be wired or wirelessly connected to an input unit, such as a keyboard, a mouse, and/or a keypad.

Although the host electronic device 100 may collect content information from client electronic devices, and may output the content information in a graphical user interface form, exemplary embodiments of the invention are not limited thereto. For example, the host electronic device 100 can also output the collected content information in textual format on the display unit 120. If the host electronic device 100 acquires information regarding a plurality of contents, the host electronic device 100 may output the information in a list format or in the format of a group containing graphic elements. The host electronic device 100 can also output the content information as graphic elements corresponding to the content information, and/or in a list on the display unit 120.

The host electronic device 100 can output, on the display unit 120, the list in the vicinity of the client electronic device, so that the user can easily identify the origin of the list. This outputting method makes it easy for a user to distinguish among the lists included in the plurality of client electronic devices.

As described above, the electronic device managing method can integrally manage files stored in a plurality of client electronic devices, and can check remaining battery capacities of the client electronic devices during file management, thereby efficiently and stably reproducing the files. A file storage state, a remaining battery capacity state, and a file reproduction state of at least one electronic device can also be integrally and efficiently managed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electronic device managing method, comprising:
arranging at least one client electronic device on a display unit of a host electronic device comprising a touch screen function;
collecting, by the host electronic device, information regarding at least one content of the at least one client electronic device; and
displaying at least one graphic element corresponding to the collected content information on the display unit of the host electronic device.

2. The method of claim 1, wherein the at least one graphic element corresponding to the content information is displayed adjacent to the corresponding client electronic device on the display unit.

3. The method of claim 1, wherein the at least one graphic element corresponding to the content information is displayed in a list or as at least one graphic element having an image corresponding to the content information.

4. The method of claim 1, further comprising:
displaying icons on the display unit of the host electronic device, wherein the icons correspond to at least one of the functions for deleting, moving, editing, and transferring the at least one content of the at least one client electronic device.

5. The method of claim 4, further comprising:
performing the at least one of the functions for deleting, moving, editing, and transferring the at least one content using the at least one graphic element corresponding to the content information and the icons displayed on the display unit.

6. The method of claim 1, wherein displaying the at least one graphic element corresponding to the collected content information comprises:
displaying, if a plurality of client electronic devices are arranged on the display unit, graphic elements corresponding to content information of each of the plurality of client electronic devices on the display unit.

7. The method of claim 6, further comprising:
receiving an input signal for moving the content information; and
moving or copying the content information from a first client electronic device arranged on the display unit to a second client electronic device arranged on the display unit, according to the input signal.

8. The method of claim 1, further comprising:
receiving an input signal for moving the content information; and
moving or copying the content information, included in a particular client electronic device arranged on the display unit of the host electronic device, to another client electronic device not arranged on the display unit of the host electronic device, according to the input signal.

9. An electronic device management system, comprising:
a host electronic device comprising a display unit supporting a touch screen function; and
at least one client electronic device to communicate with the host electronic device, the display unit of the host electronic device to display the at least one client electronic device,
wherein the host electronic device communicates with the at least one client electronic device if the at least one client electronic device is arrayed on the display unit of the host electronic device, collects content information regarding at least one content of the at least one client electronic device, and displays at least one graphic element corresponding to the collected content information on the display unit.

10. The system of claim 9, wherein the display unit displays the at least one graphic element corresponding to the content information on the display unit adjacent to the at least one client electronic device arrayed on the display unit.

11. The system of claim 9, wherein the display unit displays the at least one graphic element corresponding to the content information in a list or as at least one graphic element having an image corresponding to the content information.

12. The system of claim 9, wherein the display unit displays icons on the display unit, wherein the icons correspond to at least one of the functions for deleting, moving, editing, and transferring the at least one content in the at least one client electronic device.

13. The system of claim 12, wherein the host electronic device performs at least one of the functions for deleting, moving, editing, and transferring the at least one content using the at least one graphic element corresponding to the content information and the icons displayed on the display unit, according to a signal input via a touch screen or an input unit.

14. The system of claim 12, wherein the host electronic device receives an input signal for moving the content information, and transfers the content information of a particular client electronic device arrayed on the display unit of the host electronic device to another client electronic device arrayed on the display unit of the host electronic device or to a client electronic device not arrayed on the display unit of the host electronic device, according to the input signal.
